(19) United States
(12) Patent Application Publication
(10) Pub. No.: US 2009/0036600 A1
(43) Pub. Date: Feb. 5, 2009

(54) Novel Process for the Preparation of Polylactic Acid

(75) Inventors: Nils Dan Anders Södergard, Turku (FI); Erik Mikael Stolt, Turku (FI)

Correspondence Address: WILLIAMS, MORGAN & AMERSON, 10333 RICHMOND, SUITE 1100, HOUSTON, TX, 77042, US

(73) Assignee: Tate & Lyle Public Limited Company

(21) Appl. No.: 12/067,987

(22) PCT Filed: Sep. 28, 2005
(86) PCT No.: PCT/NL2005/000699

§ 371 Date: Jul. 15, 2008

(51) Int. Cl. C08L 67/00; C08G 63/12; C08G 63/06; C08F 2/01

(52) U.S. Cl. 524/599; 528/176; 528/209; 526/64

(57) ABSTRACT

The present invention describes a polyhydroxycarboxylic acid having bimodal or multimodal molar mass distribution, a process for the preparation thereof, the use of an aromatic diol having a single benzene ring for the preparation of polyhydroxycarboxylic acid, in particular polyhydroxycarboxylic acid having bimodal or multimodal molar mass distribution, as well as a method of preparing injection-molded goods or blown film, polymer blends, composite materials or nanocomposite materials using said polyhdroxycarboxylic acid.

The present invention relates to a polyhydroxycarboxylic acid having bimodal or multimodal molar mass distribution, a process for the preparation thereof, the use of an aromatic diol having a single benzene ring for the preparation of polyhydroxycarboxylic acid, in particular polyhydroxycarboxylic acid having bimodal or multimodal molar mass distribution, as well as a method of preparing injection-molded goods or blown film, polymer blends, composite materials or nanocomposite materials using said polyhydroxycarboxylic acid.

Polymers derived from hydroxycarboxylic acid, such as polylactic acid (PLA), are among the most promising category of polymers made from renewable resources. Besides being renewable, compostable and biocompatible, polymers derived from hydroxycarboxylic acid such as lactic acid are also processable with standard processing equipment.

Polyhydroxycarboxlic acids are used for a variety of applications, such as medical applications, e.g. sutures, coatings, and the like. Generally, high molecular weight polyhydroxycarboxylic acid is most desired for the above purposes, as polyhydroxycarboxylic acid with relatively low molecular weight results in poor mechanical properties that are not suitable for most applications. However, each application requires polyhydroxycarboxylic acid having specific properties. Therefore, in the art there is a continuous need for novel polyhydroxycarboxylic acid compositions contributing to the diversity required for various applications.

Upon conventional preparation of polyhydroxycarboxylic acid generally polyhydroxycarboxylic acid is obtained having a monomodal molar mass distribution. Polyhydroxycarboxylic acids having bimodal molar mass distribution are disclosed by Shyamroy et al. (Shyamroy S., Garnaik B. and Sivaram S. J. Polymer Sci.: Part A: Polymer Chem. 2005, vol. 43:2164-2177). The molar masses are restricted to low molecular weight fractions, one fraction having an number-average molecular weight of 3400 or 2600 respectively, and a second fraction having a number-average molecular weight of 600 or 500, respectively.

The present inventors have now found that polyhydroxycarboxylic acid having bimodal and/or multimodal molar mass distribution having higher molecular weights can be obtained upon polycondensation of hydroxycarboxylic acid in the presence of a catalyst/aromatic diol system when the aromatic diol has only a single benzene ring. The polyhydroxycarboxylic acid having bimodal molar mass distribution has a high molecular weight fraction in addition to a low molecular weight fraction, the latter also being found upon polymerisation in the presence of an aliphatic diol rather than an aromatic diol having a single benzene ring.

Thus, the present invention relates to polyhydroxycarboxylic acid having bimodal or multimodal molar mass distribution, said polyhydroxycarboxylic acid comprising at least a first fraction having a molar mass in the range of 1-200 kDa and a second fraction having a molar mass of above 200 kDa. Such polyhydroxycarboxylic acid has not before been obtained and provides a novel composition that may provide novel opportunities for specific applications, e.g. in respect of processability. Moreover, in an embodiment said polyhydroxycarboxylic acid can subsequently be further linked to obtain high molecular weight polyhydroxycarboxylic acid for further use in applications.

The bimodal or multimodal molar mass distribution is preferably determined by means of gel permeation chromatography (GPC). GPC measurements can e.g. be conducted using a system based on a Pharmacia LKB-HPLC Pump 2248, TSK-gel G3000, G2500 and G1500HXL columns and an LKB 2142 RI Detector. Monodisperse polystyrene standards are preferably used for calibration. The concentration of samples may preferably be 1.5-2 mg/ml in THF, which may also be used as the mobile phase in the GPC system.

Preferably, the second fraction has a molar mass in the range of 200-1500 kDa, as polymers having a higher molar mass are extremely viscous and difficult to handle.

Preferably, the first fraction has a molar mass in the range of 1-100 kDa, more preferably 1-50 kDa. Preferably, the second fraction has a molar mass in the range of 250-1200 kDa, more preferably of 300-100 kDa.

Hitherto, two main methods for preparing polyhydroxycarboxylic acids are known: polycondensation or ring-opening polymerisation of the ring-formed cyclic (di)ester of a hydroxycarboxylic acid. The latter is known to result in a polymer having a higher molecular weight, but is also more laborious and costly than simple polycondensation of the hydroxycarboxylic acid.

Since polyhydroxycarboxylic acid having a high molecular weight is mostly used for industrial applications, there is a continuous need in the art for simple methods of preparation of such polyhydroxycarboxylic acid. Also, it is attempted to increase the molecular weight that can be achieved. One of such methods is to perform the polymerisation in the presence of diol or diacid comonomers, which often act as chain extenders. Such polymerisation then results in the formation of prepolymers having two hydroxyl, or two carboxylic acid, end groups rather than one hydroxyl end group and one carboxylic acid end group. The prepolymer obtained may subsequently be cross-linked using chemical compounds such as isocyanates or diepoxies to obtain a high molecular weight polyhydroxycarboxylic acid.

Hiltunen and Seppälä (J. Appl. Polymer Sci. 1998, vol. 67:1011-1016) disclose the use of the combination of different catalysts and diols for the preparation of lactic acid-based prepolymers that are further subjected to a linking reaction in order to obtain a polymer having high molecular weight. Aliphatic diols or aromatic diols having 2 or more benzene rings were tested as diols, and with aromatic diols polylactic acid with a maximum average molecular weight of about 25,000 g/mol could be obtained.

The present inventors have now found that polyhydroxycarboxyolic acid having a bimodal or multimodal molar mass can be obtained when hydroxycarboxylic acid is subjected to polycondensation in the presence of a catalyst/aromatic diol system, wherein the aromatic diol has a single benzene ring. Such bimodal or multimodal molar mass distribution is not obtained when an aromatic diol having 2 or more benzene rings is used, nor when aliphatic diols are used.

Thus, the present invention relates to a process for preparing a polyhydroxycarboxylic acid, said process comprising the step of subjecting a hydroxycarboxylic acid and/or a cyclic (di)ester of a hydroxycarboxylic acid to polymerisation in the presence of a catalyst and an aromatic diol, characterised in that the aromatic diol has a single benzene ring.

It was found that polycondensation of lactic acid in the presence of a suitable metallic catalyst such as tin octoate as a catalyst and an aromatic diol as discussed above had a surprising effect on the molar mass distribution of the polymer obtained. The molar mass distribution showed bimodal peaks. In contrast, the GPC curve of a polylactic acid obtained by polycondensation of lactic acid in the presence of tin octoate as a catalyst and an aliphatic diol under identical conditions showed a single peak and lacked the additional high molecular weight polylactic acid fraction that was additionally found upon polymerisation in the presence of the single benzene ring aromatic diol.

From experiments conducted under reduced pressure it was noted that only a minor amount of the hydroxyl groups in the aromatic diol reacted with the carboxyl groups of the hydroxycarboxylic acid and/or polymer, such that the presence of the aromatic diol did not seem to limit the length of the polymer chain to the extent calculated. Thus, it seems that only few polymer chains attached to the aromatic diol. As a consequence, polyhydroxycarboxylic acid having mainly both hydroxyl and carboxylic acid end groups are obtained, with only few having a phenol end group. Thus, in contrast to aliphatic diols that act as true initiators/chain stoppers in the preparation of polyhydroxycarboxylic acids, the aromatic diols according to the present invention merely assisted the action of the catalyst, resulting in polyhydroxycarboxylic acid having a bimodal molar mass distribution. This polyhydroxycarboxylic acid was comprised of a high molecular weight fraction in addition to the fraction found upon polymerisation in the presence of an aliphatic diol.

The term “hydroxycarboxylic acid” is well known in the art. Suitable examples of the hydroxycarboxylic acid to be used as starting material in the preparation of the polyhydroxycarboxylic acid according to the present invention are lactic acid, glycolic acid, hydroxybutyric acid, hydroxyvaleric acid, and hydroxycaproic acid. When the hydroxycarboxylic acid is a chiral compound, it may have any of the D-, L- or DL-configuration.

The term “cyclic (di)ester of a hydroxycarboxylic acid” as used herein is also well known in the art. The term includes cyclic diesters of a hydroxycarboxylic acid, such as lactide, glycolide, and mandelide, as well as cyclic esters of a hydroxycarboxylic acid, such as ε-caprolactone, butyrolactone and valerolactone.

The term “polymerisation” is well known in the art. Non-limiting examples of polymerisation methods include polycondensation, i.e. the formation of a polymer by means of a chemical reaction in which two or more molecules combine with the subsequent release of water or some other simple substance, and also ring-opening polymerisation of the cyclic (di)ester of a hydroxycarboxylic acid.

Any conventional means of polycondensation for hydroxycarboxylic acids may be used, such as liquid polycondensation, melt polycondensation or solid-state polycondensation. The polycondensation is preferably carried out in a system having a highly intensive mixing/kneading of the reaction mixture with the benefit of having an efficient renewal of phase boundary layers, which enhances both mass and heat transfer without the use of solvent.

Ring-opening polymerisation of cyclic (di)esters of a hydroxycarboxylic acid can be performed in solution or in bulk. Bulk polymerisation can be carried out either below the melting point of the polymer (but above the melting point of the monomer), or above the melting point of the polymer. The latter method is mostly used as a large variety of suitable reactor systems is available, for instance extruders, kneaders, static mixers, tube reactors, etc.

The polymerisation reaction is preferably carried out in the presence of a conventional catalyst. Conventional catalysts for the polymerisation of hydroxycarboxylic acid are well known in the art. Suitable examples thereof include acids, or metallic or organometallic compounds containing elements of groups I-VIIIA and/or groups IB-VIIN in the Periodic Table of Elements, such as tin octoate, toluenesulphonic acid, sulphuric acid, titanium acetylacetonate, and antimony, iron, zinc, osmium, and germanium with various ligands.

The aromatic diol is characterised in that it has a single benzene ring. It was found that such aromatic diols aid the formation of a polyhydroxycarboxylic acid having bimodal or multimodal molar mass distribution, and preliminary evidence indicates that they may improve reaction rate.

Typical amounts of the catalyst and aromatic diol are in the range of 0.01-0.5 mol % and most commonly about 0.1 mol %.

Preferably, the polyhydroxycarboxylic acid has bimodal or multimodal molar mass distribution, and more preferably comprises at least a first and a second fraction, the fractions having a molar mass in the range of 1-1500 kDa. Most preferably, the polyhydroxycarboxylic acid comprises at least a first fraction having a molar mass in the range of 1-200 kDa and a second fraction having a molar mass of above 200 kDa, for reasons indicated above.

Preferably, the second fraction has a molar mass in the range of 200-1500 kDa, for reasons discussed above.

In one embodiment, the polymerisation is polycondensation. The resulting product having bimodal or multimodal molar mass distribution comprises a high molecular weight second fraction that is unprecedented for polycondensation methods. Such polyhydroxycarboxylic acid may be further linked to obtain polyhydroxycarboxylic acid with a yet higher molecular weight.

In a further embodiment, the polymerisation occurs in two steps, one step being polycondensation and one step being ring-opening polymerisation. Thus, in one step a hydroxycarboxylic acid is subjected to polycondensation in the presence of a catalyst and an aromatic diol according to the present invention to obtain a first polymer. In another step, a cyclic (di)ester of a hydroxycarboxylic acid may be added to the first polymer and this may be subjected to ring-opening polymerisation to obtain a polyhydroxycarboxylic acid having a higher average molar mass.

Preferably, the aromatic diol has the following structure:

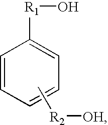

wherein R₁ and R₂ are aliphatic substituents. It is expected that with such aromatic diol bimodal or multimodal molar mass distribution will be obtained.

More preferably, the aromatic diol has the following structure:

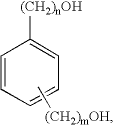

wherein n is an integer chosen from 0 or 1, and m is an integer chosen from 0, 1 or 2. It was found that with such aromatic diol bimodal or multimodal molar mass distribution was obtained.

It was found that with the following specific compounds the best results were obtained with regard to reaction rate and molecular weight.

The substituents could be located on the following positions of the molecule:

| | Position of the second substituent | |
|---|---|---|
| n | (containing m methylene groups) | m |
| 0 | ortho | 2 |
| 0 | meta | 2 |
| 0 | para | 2 |
| 0 | ortho | 1 |
| 0 | meta | 1 |
| 0 | para | 1 |
| 1 | ortho | 1 |
| 1 | meta | 1 |
| 1 | para | 1 |

Examples of such aromatic diols are set forth below.

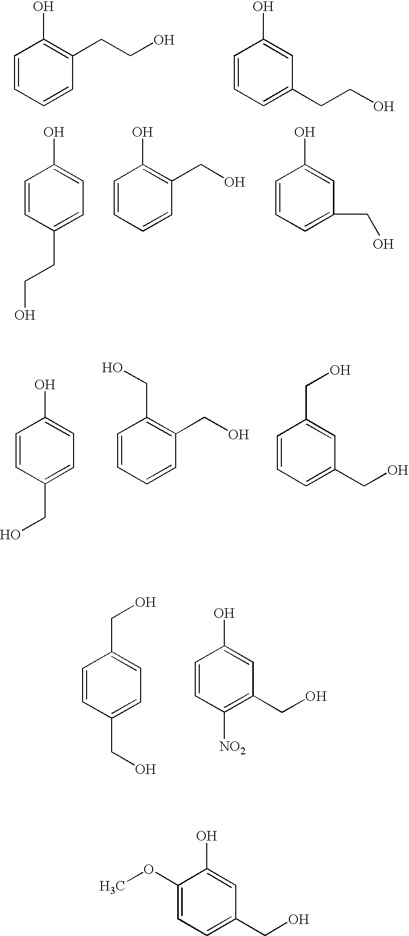

In a preferred embodiment, n is 0 and m is 1, said compound being 2-hydroxyphenethyl alcohol. It was found that with such aromatic diol a polymer with a bimodal molas mass distribution was obtained.

Preferably, the hydroxycarboxylic acid is chosen from one or more of the group, consisting of glycolic acid, butyric acid, valeric acid, caproic acid and lactic acid.

The cyclic (di)ester of the hydroxycarboxylic acid is preferably chosen from one or more of the group, consisting of glycolide, caprolactone, and lactide.

In an embodiment, the hydroxycarboxylic acid is lactic acid and/or the cyclic (di)ester of the hydroxycarboxylic acid is lactide. The problem of poor mechanical properties in case of a low molecular weight polymer is particularly obvious for polylactic acid (PLA), and thus the present invention is particularly relevant for PLA.

In case of polycondensation according to the present invention, the polycondensation advantageously comprises the steps of i) pre-melt-polycondensation, ii) melt-polycondensation and iii) solid-state polycondensation.

In step i) the hydroxycarboxylic acid is converted into low molecular weight polyhydroxycarboxylic acid. In the step the removal of water is not critical due to the relatively low viscosity of the reaction mixture. The rate-determining step in step i) is the chemical reaction, i.e. the polycondensation reaction of hydroxycarboxylic acid, which is significantly affected by the catalyst used.

The pre-melt-polycondensation of hydroxycarboxylic acid of step i) to a low molecular mass polyhydroxycarboxylic acid may for example be carried out in an evaporator, like a falling film evaporator. The loss of hydroxycarboxylic acid due to entrainment can be overcome by having a reflux condensor, a demister package or a rectification column. Step i) can also be carried out in a stirred reactor, having an agitator that generates good radial and axial mixing. Preferably, the pre-melt-polycondensation of step i) is carried out in a system having a narrow residence time distribution (plug flow behaviour) in order to obtain a prepolymer of the hydroxycarboxylic acid having a narrow molecular weight distribution (small dispersion).

Step ii) is the melt polycondensation in which the water becomes more difficult to remove. In order to give preference to the polycondensation reaction over the also occurring trans-esterification reactions, the water formed in the reaction mixture should be removed. The rate-determining step in step ii) is the mass transfer of water. In order to enhance both mass and heat transfer, the melt polycondensation reaction is preferably conducted in an apparatus having very efficient renewal of phase boundary layers. The apparatus preferably has very intensive mixing and kneading in order to homogenise the reaction mixture. Carrying out the reaction under vacuum conditions in an inert atmosphere can further enhance the removal of water from the viscous polylactic acid mass.

The melt polycondensation is preferably carried out in a system having good mass and heat transfer and intensive mixing and kneading of the mixture. Because of the increasing molecular weight of hydroxycarboxylic acid, preferably a system capable of handling high viscosity mass is used. Such an apparatus could be rotating disc type of reactors, generating a good surface renewal in order to enhance the mass transfer over the water formed. Such an apparatus preferably also has very good heat transfer in order to have a homogeneous temperature profile in the reaction mixture. Especially the mechanical heat formed due to mixing and kneading of the (high) viscous polyhydroxycarboxylic acid should be controlled.

The pre-melt-polycondensation of step i) and the melt polycondensation of step ii) may be performed in any suitable manner known in the art, for example by starting to heat the reaction mixture from ambient temperature to 190° C. simultaneously utilizing a pressure of 1000 mbar. When enough of the free and reaction water has evaporated and the reaction mixture has reached the required temperature, the pressure may be lowered in, for example, 20 minutes intervals with the following steps: 800mbar—700 mbar—600 mbar—500 mbar—400 mbar—320 mbar—270 mbar—220 mbar—170 mbar—120 mbar—90 mbar—30 mbar.

As the condensation reaction proceeds the amount of reaction water will further decrease and the pressure reduction may even further be lowered in order to enhance the evaporation of the freed reaction water, for example in 30 minutes intervals with the following pressure reduction steps: 20 mbar—10 mbar—5-mbar.

To even further remove the small amounts of reaction water formed, the pressure can be lowered to the lowest obtainable pressure level. Optionally, a purge of inert gas (e.g. nitrogen or argon) may be used to assist the removal of formed reaction water.

In step iii), the product of step ii) is subjected to solid-state-polycondensation, i.e. crystallisation. When applying crystallisation of polyhydroxycarboxylic acid, the polycondensation reaction proceeds in the amorphous phase. The rate-determining step in step iii) is mass transport by molecular diffusion. In order to enhance both mass and heat transport, the solid-state-polycondensation reaction should be conducted in an apparatus having very efficient renewal of phase boundary layers, as discussed above for the melt-polycondensation of step ii). The apparatus preferably provides very intensive mixing and kneading in order to homogenise the reaction mixture. Carrying out the reaction under vacuum conditions in an inert atmosphere can further enhance the removal of water.

The crystallisation/solidifying temperature of polyhydroxycarboxylic acid is dependant on both the type of PHA, its molecular weight and its stereochemical structure. Below the crystallisation/solidifying temperature two phases can be identified: a crystalline phase and an amorphous phase, whereas only one phase—the liquid phase—is detected above the crystallisation/solidifying temperature. In the amorphous phase the reactive end groups (hydroxy and carboxylic acid groups) are concentrated. This concentration of end groups can enhance the rate of polycondensation.

The solid-state polycondensation step iii) may be performed, following crystallization of the polyhydroxycarboxylic acid, at a temperature below the melting point of the polyhydroxycarboxylic acid, such as for example 140-160° C. in the case of poly(lactic acid), utilizing pressure as low as possible, preferably below 5 mbar, optionally with a purge of inert gas (e.g. nitrogen or argon) to assist in the removal of formed reaction water.

The solid-state-polycondensation of step iii) as well the transition phase between the melt and the solid-state-polycondensation can be carried out in the same apparatus as described for the melt polycondensation of step ii). Preferably the melt or solid-state-polycondensation is carried out in a system having a narrow residence time distribution (plug flow behaviour) in order to obtain a polymer of hydroxycarboxylic acid having a narrow molecular weight distribution (small dispersion).

Preferably, in this case the catalyst is an (organo)metallic catalyst, as such catalyst can efficiently catalyse both the solid-state-polycondensation as well as the melt polycondensation. These catalyst can be different metals, metal oxides or organometallic compounds containing one or more transition metals like Sn, Ti or Zn.

It is highly preferred that preceding polycondensation the hydroxycarboxylic acid is treated as to remove free water. Hydroxycarboxylic acid, e.g. lactic acid obtained as a by-product in dairy industry, may contain besides lactic acid also water, so-called free water. Due to the equilibrium of this lactic acid and water a low amount of oligomers of lactic acid (linear dimer, linear trimer etc) can already be formed. In order to convert lactic acid to polylactic acid first the free water has to be removed. Alternatively, relatively concentrated hydroxycarboxylic acid may be used such that this evaporation step may not be required.

The evaporation of the free water, optional step a), requires a system having good heat transfer, and can be carried out in commonly known evaporators, like for example falling film evaporators. A flash evaporation can also take care of the removal of the free water content in hydroxycarboxylic acid.

Besides the removal of water from the reaction mixture, polylactic acid, also the lactide formed as a by-product will be removed. It is believed that formation of lactide cannot be completely excluded, but in order to suppress the lactide formation and to increase the first pass yield of the polycondensation reaction of lactic acid, the lactide removed could be returned back to the reaction mixture. A partial condenser (reflux condenser) or a rectification column placed on top of the reaction vessel the polycondensation reaction is carried out in, may ensure the recycling of lactide to the reaction mixture.

It is also preferred that the polymerisation is at least partially carried out under vacuum conditions. It was found that such conditions ensure most effective removal of water from the polycondensation reaction, which may be advantageous for the further progress of the reaction.

In a further embodiment, the polymerisation is at least partially carried out in a kneader, extruder, static mixer, tube reactor or heated vessel, i.e. a system having good mass and heat transfer and intensive mixing and kneading of the mixture, for reasons given above.

It is highly preferred that the polymerisation is at least partially carried out in an inert atmosphere. It was found that such conditions limit unwanted side reactions. By flushing inert gas through the reactor the most effective removal of water from the polycondensation reaction is reached, which may be advantageous for the further progress of the reaction.

The present invention also relates to a polyhydroxycarboxylic acid obtainable by any of the methods according to the present invention.

In a further aspect, the present invention relates to the use of an aromatic diol having a single benzene ring for the preparation of polyhydroxycarboxylic acid.

Preferably, the aromatic diol has the following structure:

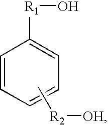

wherein R₁ and R₂ are aliphatic substituents, for reasons set forth above.

It is even more preferred that the aromatic diol has the following structure:

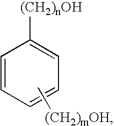

wherein n is an integer chosen from 0 or 1, and m is an integer chosen from 0, 1 or 2, as discussed above.

Preferably, the polyhydroxycarboxylic acid obtained has a bimodal or multimodal molar mass distribution. Preferably, the the polyhydroxycarboxylic acid comprises at least a first fraction having a molar mass in the range of 1-200 kDa and a second fraction having a molar mass of above 200 kDa. More preferably the second fraction has a molar mass in the range of 200-1500 kDa.

In an embodiment, the polyhydroxycarboxylic acid is polylactic acid, for reasons already stated above.

As already mentioned before, a high molecular weight polyhydroxycarboxylic acid is obtained by linking of the polyhydroxycarboxylic acid having a bimodal molar mass distribution. The polyhydroxycarboxylic acid comprises a high molecular weight fraction unprecedented that can advantageously be used to easily obtain a high molecular weight polyhydroxycarboxylic acid using linking reactions.

It is well known in the art how polymers having carboxylic acid and/or hydroxyl end groups can be linked together. Chain extension can e.g. be performed by applying compounds reactive with either hydroxyl groups (e.g. anhydrides, isocyanates) or carboxylic acid groups (e.g. epoxides, oxazolines). Another way of linking involves radical induced reactions, e.g. by organic peroxides or other initiators.

In yet a further aspect, the present invention also relates to a method for preparing injection-molded goods or blown film, characterised in that a polyhydroxycarboxylic acid according to the present invention is used. Such polymer having bimodal or multimodal molar mass distribution may be particularly suitable for such application.

In an embodiment the polyhydroxycarboxylic acid according to the present invention is used for preparing polymer blends, composite materials or nanocomposite materials.

It is preferred that the polyhydroxycarboxylic acid is used in combination with one or more additives, chosen from the group, consisting of fillers, reinforcement agents, plasticisers, impact modifiers, stabilisers, colouring agents, flame retardants, anti-bloc agents, and initiators, or other commonly used additives for the applications disclosed above.

The invention will now be described further by means of the following examples and figures, which are in no way meant to be construed as limiting the scope of the present invention.

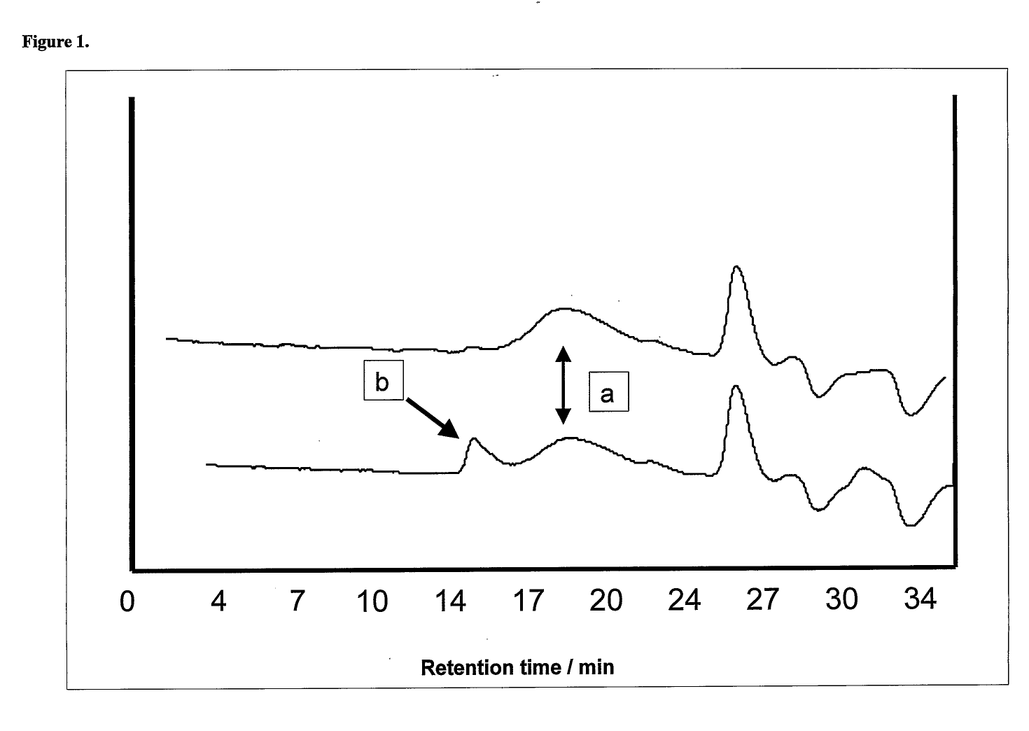

FIG. 1 shows a GPC chromatogram of polylactic acid having bimodal molar mass distribution (bottom line) which is prepared by the method according to the present invention in the presence of an aromatic diol versus polylactic acid prepared in the presence of an aliphatic diol (top line).

### EXAMPLES

### Example 1

### Effect of the Aromatic Diol on Molecular Mass

An amount of 800 g L-lactic acid was dried at 100° C. at 50 mbar overnight. Next, the polycondensation reaction was started, first by adjusting the pressure to ˜800 mbar, followed by a temperature increase of 10° C./15 min. At the start of the reaction 1 g tin-octoate and 0.5 g of 2-hydroxyphenethyl alcohol were added. The final temperature was 200° C. and when the end temperature was reached, the pressure was gradually reduced to 20 mbar and the polycondensation continued for 16 hours. Another polymerisation was also made at the same conditions and according to the same method, but in the presence of an aliphatic diol (butanediol). After the reaction was completed the reaction mixtures were cooled down to room temperature and solid yellow polylactic acid was collected and characterised by Gel Permeation Chromatography (GPC).

Gel Permeation Chromatography (GPC) measurements were conducted by using a system based on a Pharmacia LKB-HPLC Pump 2248, TSK-gel G3000, G2500 and G1500HXL columns and an LKB 2142 RI Detector. Monodisperse polystyrene standards were used for calibration. The concentration of the samples was about 1.5-2 mg/ml in THF, which was also used as the mobile phase in the GPC system.

The GPC spectra showed an additional peak (peak b in FIG. 1) for the polymerisation product prepared in presence of the aromatic diol in comparison to the product prepared in the presence of the aliphatic diol corresponding to a molecular weight (M_{w}) of 2000-20000 g/mol (peak a in FIG. 1). The additional peak is of significant size and indicates a molecular weight of several hundred thousands g/mol (Da) for the fraction.

1. Polyhydroxycarboxylic acid having bimodal or multimodal molar mass distribution, said polyhydroxycarboxylic acid comprising at least a first fraction having a molar mass in the range of 1-200 kDa and a second fraction having a molar mass of above 200 kDa.

2. Polyhydroxycarboxylic acid according to claim 1, wherein the second fraction has a molar mass in the range of 200-1500 kDa.

3. Process for preparing polyhydroxycarboxylic acid, said process comprising the step of subjecting hydroxycarboxylic acid and/or cyclic (di)ester of a hydroxycarboxylic acid to polymerisation in the presence of a catalyst and an aromatic diol, characterised in that the aromatic diol has a single benzene ring.

4. Process according to claim 3, wherein the polyhydroxycarboxylic acid is polyhydroxycarboxylic acid having bimodal or multimodal molar mass distribution.

5. Process according to claim 4, wherein the polyhydroxycarboxylic acid comprises at least a first and a second fraction, the fractions having a molar mass in the range of 1-1500 kDa.

6. Process according to claim 3, wherein the polyhydroxycarboxylic acid comprises at least a first fraction having a molar mass in the range of 1-200 kDa and a second fraction having a molar mass of above 200 kDa.

7. Process according to claim 6, wherein the second fraction has a molar mass in the range of 200-1500 kDa.

8. Process according to claim 3, wherein the polymerisation is polycondensation.

9. Process according to claim 3, wherein the polymerisation occurs in two steps, one step being polycondensation and one step being ring-opening polymerisation.

10. Process according to claim 3, wherein the aromatic diol has the following structure: 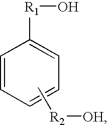
wherein R₁ and R₂ are aliphatic substituents.

11. Process according to claim 3, wherein the aromatic diol has the following structure: 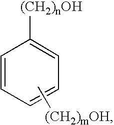
wherein n is an integer chosen from 0 or 1, and m is an integer chosen from 0, 1 or 2.

12. Process according to claim 3, wherein the hydroxycarboxylic acid is chosen from one or more of the group, consisting of lactic acid, glycolic acid, hydroxybutyric acid, hydroxyvaleric acid, and hydroxycaproic acid.

13. Process according to claim 3, wherein the cyclic (di)ester of the hydroxycarboxylic acid is chosen from one or more of the group, consisting of lactide, glycolide, mandelide, ε-caprolactone, butyrolactone and valerolactone.

14. Process according to claim 3, wherein the hydroxycarboxylic acid is lactic acid and/or the cyclic (di)ester of the hydroxycarboxylic acid is lactide.

15. Process according to claim 8, wherein the polycondensation comprises the steps of i) pre-melt-polycondensation, ii) melt-polycondensation and iii) solid-state polycondensation.

16. Process according to claim 8, wherein preceding polycondensation the hydroxycarboxylic acid is treated as to remove free water.

17. Process according to claim 3, wherein the polymerisation is at least partially carried out under vacuum conditions.

18. Process according to claim 3, wherein the polymerisation is at least partially carried out in a kneader, extruder, static mixer, tube reactor or heated vessel.

19. Process according to claim 3, wherein the polymerisation is at least partially carried out in an inert atmosphere.

20. A method of using an aromatic diol having a single benzene ring for the preparation of polyhydroxycarboxylic acid.

21. Method according to claim 20, wherein the aromatic diol has the following structure: 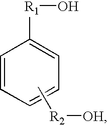
wherein R₁ and R₂ are aliphatic substituents.

22. Method according to claim 21, wherein the aromatic diol has the following structure: 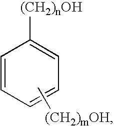
wherein n is an integer chosen from 0 or 1, and m is an integer chosen from 0, 1 or 2.

23. Method according to claim 20, wherein the polyhydroxycarboxylic acid has a bimodal or multimodal molar mass distribution.

24. Method according to claim 23, wherein the bimodal or multimodal molar mass distribution shows at least a first fraction having a molar mass in the range of 1-200 kDa and a second fraction having a molar mass of above 200 kDa.

25. Method according to claim 20, wherein the polyhydroxycarboxylic acid is polylactic acid.

26. Method according to claim 20, wherein a high molecular weight polyhydroxycarboxylic acid is obtained by cross-linking of the polyhydroxycarboxylic acid having a bimodal molar mass distribution.

27. Method for preparing injection-molded goods or blown film, characterised in that the polyhydroxycarboxylic acid as defined in claim 1 or a polyhydroxycarboxylic acid prepared by the process as defined in claim 3 is used.

28. Method for preparing polymer blends, composite materials or nanocomposite materials, characterised in that the polyhydroxycarboxylic acid as defined in claim 1 or a polyhydroxycarboxylic acid prepared by the process as defined in claim 3 is used.

29. Method according to claim 27, characterised in that the polyhydroxycarboxylic acid is used in combination with one or more additives, chosen from the group, consisting of fillers, reinforcement agents, plasticisers, impact modifiers, stabilisers, colouring agents, flame retardants, anti-bloc agents, and initiators.
